(19) United States
(12) Patent Application Publication
(10) Pub. No.: US 2026/0303822 A1
(43) Pub. Date: Oct. 1, 2026

(54) SYSTEMS AND METHODS FOR DYNAMICALLY ADJUSTING SCHEMES FOR ENCODING LIVE VIDEO STREAMS IN RESPONSE TO CHANGES IN VIDEO COMPLEXITY

(71) Applicant: Adeia Guides Inc., San Jose, CA (US)

(72) Inventors: Evgeny Kaminsky, Hollywood, FL (US); Christopher Phillips, Hartwell, GA (US); Reda Harb, Saint Petersburg, FL (US); Tao Chen, Palo Alto, CA (US)

(21) Appl. No.: 19/095,942

(22) Filed: Mar. 31, 2025

(51) Int. Cl. H04N 19/14; H04N 19/124; H04N 19/154; H04N 19/172; H04N 19/30; H04N 19/463

(52) U.S. Cl. CPC H04N 19/14; H04N 19/124; H04N 19/154; H04N 19/172; H04N 19/30; H04N 19/463

(57) ABSTRACT

Systems and methods are provided for dynamically adjusting encoding schemes for live video streaming in response to changes in video complexity. A plurality of first live video streams are encoded at predetermined bitrates from a source video at a first picture resolution. First video quality metrics are determined for each first live video stream and incorporated into a streaming manifest generated for the source video. The source video is monitored to determine a complexity metric for a first scene of the source video. A second picture resolution is determined for the source video based on comparing the complexity metric with a complexity metric threshold, and one or more second live video streams are encoded from the source video at a second picture resolution. Second video quality metrics are determined for each second live video stream and incorporated into the streaming manifest.

### BACKGROUND

This disclosure is related to systems and methods for dynamically adjusting schemes for encoding live video streams, particularly the picture resolutions of the encoded live video streams and resource allocation, in response to changes in complexity of the source video.

### SUMMARY

Maintaining optimal video quality while efficiently utilizing network and encoding resources can be a significant challenge in live video streaming. Typically, video streaming systems encode a source video at a selected picture resolution to generate several live video streams at predetermined bitrates. The video streaming system also generates a streaming manifest to provide recipient devices with information about each live video stream available for the source video. Among other information, the streaming manifest generally includes the picture resolution and the bitrate associated with each live video stream. By referencing the streaming manifest, a recipient device may select, from among the available live video streams, the live video stream having the bitrate and picture resolution that will present the best picture quality when viewed on the display of the recipient device.

One problem streaming systems encounter when following this typical video encoding and streaming process is that when the various live video streams are encoded, the differences in complexity (generally defined as the amount of change present in a video from one frame to the next; e.g., a high motion scene in a source video exhibits high complexity, and a scene with few variations from frame to frame exhibits low complexity) for different parts of the source video is not taken into account. By not accounting for differences in complexity, streaming systems may generate encoded live video streams that exhibit undesirable artifacts, such as blocking and/or contouring, when a high complexity part of a source video is encoded at a high resolution (e.g., 1080p, 4K, etc.). Such artifacts may impact only certain parts of a live video stream. For example, when substantial portions of the source video are generally of medium or low complexity, yet the source video also includes a scene with high complexity, the encoding process may result in suboptimal quality in the live video streams for the high complexity scene. The reduction in quality may occur because the streaming system encodes the live video streams based on the complexity of all or part of the source video, such that the streaming system encodes the high complexity scene using the same parameters as the low or medium complexity other scenes of the source video.

Previously, this quality degradation has been managed by streaming systems employing encoding schemes that require the use of additional resources (e.g., network bandwidth resources, encoding resources, etc.). One prior encoding scheme for addressing this type of quality degradation involves the streaming system encoding the source video at a higher bitrate (e.g., 7.5 Mbps or more) and at a high resolution (e.g., 4k) to eliminate the artifacts. However, encoding at a higher bitrate necessarily increases the burden on encoding resources and increases the use of network bandwidth resources required to communicate the high bitrate live video streams to recipient devices. Another prior encoding scheme for addressing this type of quality degradation involves the streaming system encoding versions of the live video stream at the same bitrate using different picture resolutions of the source video. This solution uses more encoding and storage resources while not satisfactorily addressing the quality degradation issue. Moreover, drawbacks of both prior encoding schemes are amplified for streaming systems that encode live video streams for multiple source videos that are live streamed simultaneously.

A need therefore exists to improve encoding schemes used by streaming systems to encode live video streams. Such improvements should account for variations in complexity within a source video and be directed toward optimizing video quality displayed on recipient devices and optimizing the use of available resources during encoding and communicating live video streams. To address this need and overcome the shortcomings introduced by existing video streaming systems that do not account for source videos that include variations in complexity, systems and methods that dynamically adjust schemes for encoding live video streams are disclosed herein. These systems and methods may be used advantageously for streaming video that is encoded for live streaming using encoding schemes that aids recipient devices to select the live video stream that optimizes viewing quality and aids the streaming system to use encoding schemes that optimize the allocation of encoding and network resources. Such encoding schemes may analyze the source video to identify changes in complexity and dynamically adjust the encoding scheme to account for these changes in complexity.

In some embodiments, the streaming system may initiate encoding of a source video to generate a plurality of live video streams, with each live video stream encoded at one of a plurality of predetermined bitrates. As part of the encoding process, the streaming system determines a video quality metric for each live video stream and incorporates encoding parameters and the video quality metric into a streaming manifest associated with the source video. In response to receiving a live stream request for the source video from a recipient device, the streaming system communicates the streaming manifest and begins streaming the live video stream selected by the recipient device. Also, as part of the encoding process, the streaming system monitors the source video to determine a complexity metric for different parts of the source video. When the complexity metric crosses a complexity metric threshold, the streaming system determines a second picture resolution for the source video, and the streaming system also encodes the source video at the second resolution at one or more of the predetermined bitrates to generate at least one additional live video stream. As with the other live video streams, the streaming system determines a video quality metric for each additional live video stream and updates the streaming manifest for the source video with encoding parameters and the video quality metric associated with each additional live video stream. The streaming server then communicates the updated streaming manifest to recipient devices. Through this process, each recipient device may select, based on the video quality metrics in the streaming manifest, the live video stream that would present the best picture for viewing on the respective recipient device. Moreover, this streaming process enables the recipient device to change to change to a different live video stream in the ABR ladder to present an improved picture quality on the recipient device for different parts of the source video, thus enabling the recipient device to optimize the viewing experience for users of recipient devices.

In some embodiments, the streaming system may be responsible for simultaneously streaming several source videos to recipient devices. In such situations, it may be beneficial for the streaming system to estimate the resource load required for streaming the several source videos and compare the estimated resource load to a resource load threshold, which is based on the estimated available resources) to determine whether adjustments should be made to encoding to better accommodate the estimated available resources as streaming proceeds. The resources, in some embodiments, may be encoding resources, network resources, storage resources, among other types of resources.

In some embodiments that estimate and allocate resources, the streaming system may activate encoders to encode a plurality of live video streams based on the source video at a first picture resolution, with each live video stream encoded at one of a plurality of predetermined bitrates. As part of the encoding process, the streaming system determines complexity metrics for parts of the source video. When one of the complexity metrics crosses a complexity metric threshold, the streaming system determines a second picture resolution for the source video and activates one or more additional encoders to encode one or more additional live video stream based on the source video at the second picture resolution. Each of the one or more additional live video streams is encoded at one of the predetermined bitrates. The streaming system also determines a video quality metric for each live video stream and incorporates the video quality metrics into the streaming manifest along with encoding parameters for each associated live video stream. During the encoding process for any of the source videos, the streaming system estimates resource load needed to encode and stream all the live video streams and compares the estimated resource load with the estimated available resources. If the estimated resource load exceeds the estimated available resources, the streaming system may deactivate one or more of the encoders to reduce the estimated resource load. By deactivating one or more of the encoders, the streaming system can reduce the load on encoders, the network load, and the load on storage. Other resources may also see a reduced load by deactivating encoders.

In some embodiments that estimate and allocate resources, the streaming system may include a transcoder, an ABR packager, and a content delivery network. Such a streaming system may estimate resource load needed to encode and stream all the live video streams to make available to recipient devices video streams that are high quality while also minimizing artifacts and distortions during video scenes that have high motion content. This type of streaming system may also estimate encoder resources and network distribution and storage resources to aid in delivering high quality video streams to recipient devices. To this end, the streaming system identifies videos to be encoded and distributed, generates estimates for encoding the videos based on the type of content and an ABR ladder appropriate for the content. The streaming system receives and transcodes the videos according to the ABR ladder and may also encode additional video streams at bitrates already included in the ABR ladder, but using different picture resolutions for the source video. The packager may then analyze the encoded video streams to generate quality metrics for segments of each video steam, and multiplex video streams having the same bitrate and sufficiently different quality metrics. When generating the streaming manifest, the multiplexed segments of video streams, along with their associated parameters and quality metrics, may be included in the streaming manifest so that recipient devices may select the video stream having the picture resolution that is best suited for display by each respective recipient device. Moreover, when resources become limited (e.g., encoders are needed to encode other videos, storage space for the content delivery network is getting low, etc.), the streaming system may discontinue multiplexing and packaging the video stream at the alternate picture resolution to reduce resource demands. Conversely, if more encoders become available and more storage space is available on the content delivery network, then the streaming system may allocate additional encoding resources to encode additional video streams for one or more source videos.

In view of these improvements, streaming systems may be enabled to dynamically adjust encoding schemes to provide recipient devices with an improved selection of higher quality streaming videos.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale. The figures include:

FIG. 1 schematically illustrates a process of dynamically adjusting schemes for encoding live video streams based on the complexity of parts of the source video, in accordance with embodiments of the disclosure;

FIG. 2 is a sequence diagram illustrating a sequence of steps to dynamically adjust schemes for encoding live video streams based on the complexity of parts of the source video, in accordance with embodiments of the disclosure;

FIG. 3 is a flowchart showing an exemplary process of dynamically adjusting schemes for encoding live video streams based on the complexity of parts of the source video, in accordance with embodiments of the disclosure;

FIG. 4 is a flowchart showing an exemplary process of dynamically adjusting resources for encoding live video streams based on the source video, in accordance with some embodiments of this disclosure;

FIGS. 5A-D illustrate an exemplary streaming system, in the form of a packager and a content delivery network, an exemplary schematic representation of an encoded video, and an exemplary streaming manifest, which together support dynamically adjusting resources for encoding live video streams to enable generation of duplicate bitrate video streams that are used to provide recipient devices with video stream display options that may be used to improve picture quality of the displayed video, in accordance with embodiments of the disclosure;

FIGS. 6A-B show a flowchart of an exemplary process of determining whether an option for optimization is available and supported for live stream videos received from an encoder, in accordance with embodiments of the disclosure;

FIGS. 7A-B show a flowchart of a first exemplary process of analyzing live video streams to determine the video quality metric and packaging the live video streams for streaming, in accordance with embodiments of the disclosure;

FIGS. 8A-B show a flowchart of a second exemplary process of analyzing live video streams to determine the video quality metric and packaging the live video streams for streaming, in accordance with embodiments of the disclosure;

FIGS. 9A-B show a flowchart of a third exemplary process of analyzing live video streams to determine the video quality metric and packaging the live video streams for streaming, in accordance with embodiments of the disclosure;

FIG. 10 illustrates an exemplary streaming system for streaming video over a network to one or more recipient devices, in accordance with embodiments of the disclosure; and

FIG. 11 illustrates exemplary recipient devices for receiving streaming video over a network from a streaming system.

### DETAILED DESCRIPTION

Systems and methods are described herein for dynamically adjusting picture resolution of streamed video in response to changes in estimated bandwidth. The systems and methods may be used to improve the visual quality of streamed video on a recipient device due to changes in encoding bitrate that may be necessitated by changes in the estimated bandwidth of the network connection between the streaming server and the recipient device. Advantageously, the systems and methods may be used to improve the user experience for low-latency and/or interactive video streaming and in other video streaming environments where single-pass encoding is utilized. The systems and methods may also be used to improve the visual quality of streamed video in streaming environments to enhance the benefits of using adaptive bitrate (ABR) ladders.

As used herein, the term “source video” refers to any video media content that is encoded for streaming. The term “video stream” refers to the encoded video that results from encoding a source video with a video codec. The media content may originate from a broadcast provider, a video-on-demand provider, a video camera, or any other media source. The terms “scene”, and variants thereof, refer to a section of a source video or a video stream, the boundaries of which may be cinematically defined by the video content or may be defined by differences identified between sequential frames. In some embodiments, the differences identified between frames may be based on differences in complexity exhibited between sequential frames (e.g., high motion in the video as compared to low motion in the video). The term “segment” and variants thereof refer to a section of a video stream that starts with an IDR (instantaneous decoder refresh) frame and includes all sequential frames up to a frame immediately prior to the next IDR frame or, if there is not next IDR frame, up to and including the frame at the end of the video stream. The term “fragment” and variants thereof refer to a section of a video stream that starts with an IDR frame and includes fewer sequential frames than the current segment.

As used herein, the terms “streaming system” and “streaming server”, and variants thereof, refer to any computing system, whether monolithic or distributed, which employs control circuitry to execute and perform instructions defining any process or combination of processes described herein. Variants of the terms “streaming system” and/or “streaming server” may be used to differentiate between different electronic computing systems for purposes of this disclosure, even though the computing systems may otherwise be of identical construction. The use of a variant is not intended to indicate any differences between computing systems unless such differences are expressly indicated herein.

As described herein, the terms “user device” and “recipient device”, and variants thereof, refer to any electronic device with which a person, the user, may interact with to send and/or receive streaming video. Variants of the terms “user device” and/or “recipient device” may be used to differentiate between different devices for purposes of this disclosure, even though the devices may otherwise be of identical construction. The use of a variant is not intended to indicate any differences between devices unless such differences are expressly indicated herein.

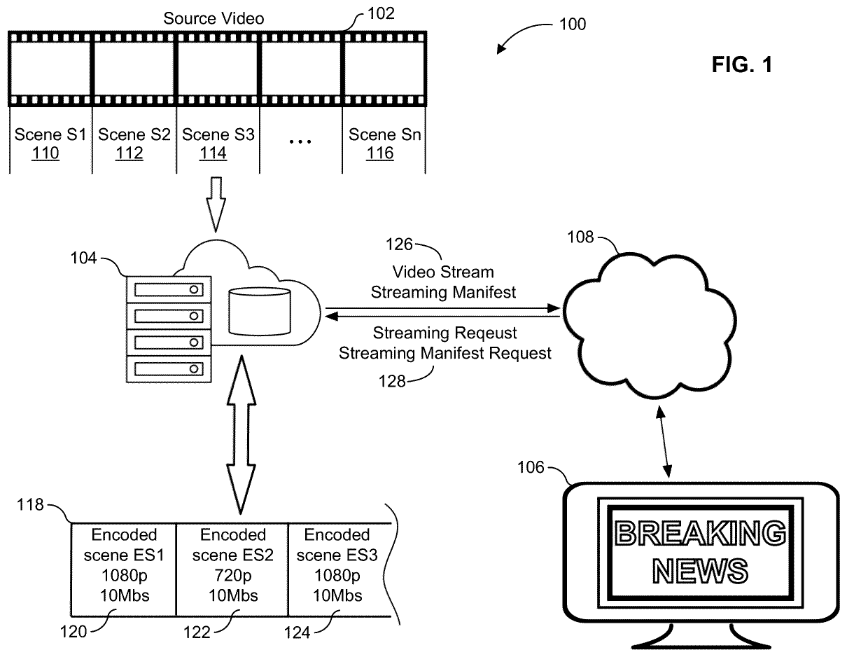

Turning in detail to the drawings, FIG. 1 illustrates a process 100 that may be used to dynamically adjust schemes for encoding live video streams based on the complexity of scenes in the source video 102. As shown, the source video 102 is processed by a streaming server 104 and communicated to a requesting device 106 via a network 108. The source video 102 itself is not streamed. Rather, the streaming server 104 encodes or transcodes the source video 102 to generate at least one video stream, and the video stream is communicated to the requesting device 106. The process of FIG. 1 is suitable for, but not limited to, streaming a live video stream from the source video 102 that is generated in real-time. Thus, several of the steps of the process 100 may be performed simultaneously to deliver a live video stream to the recipient device 106.

In some embodiments, the streaming server 104 encodes the source video 112 according to an ABR ladder that is pre-selected for the source video 102 based on characteristics known about the source video 102 in advance of processing by the streaming server 104. Such characteristics may include whether the source video 102 is a creative content (e.g., a movie or tv show) and the categorization of the creative content (e.g., action movie, drama, thriller, comedy, documentary, reality program, etc.) or whether the source video 102 is a sports video, a news program video, podcast video, or other type of real-time video content. Each of these different types of source videos may result in a different ABR ladder being selected for the encoding.

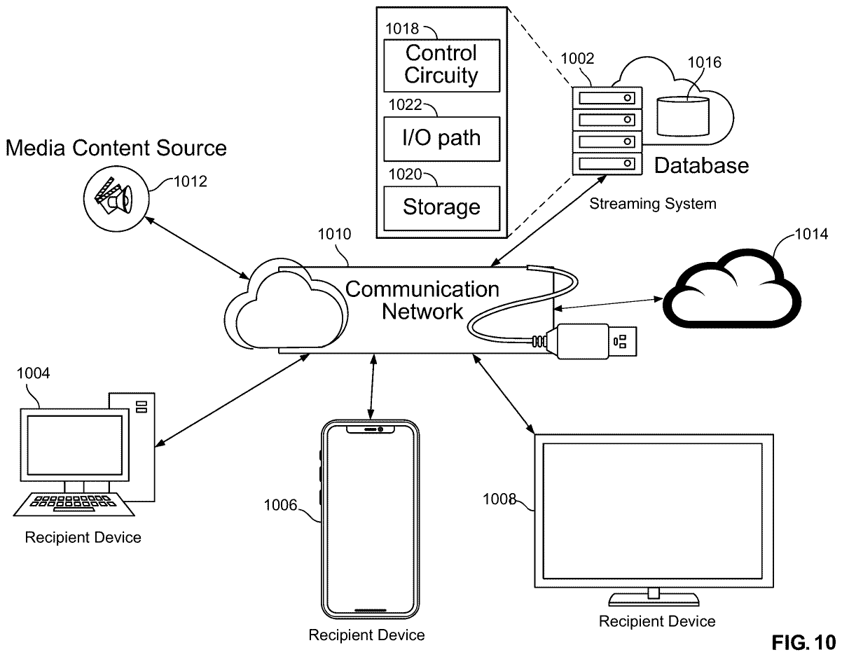

As discussed herein, the process 100 performed by the streaming server 104 may be a distributed process performed by a streaming system. Also as discussed herein, the network 108 may be a private network, a public network, a wireless network, a wired network, and the like, or any combination of different types of networks. And, though one example of a video stream is shown, as discussed herein, the streaming server 104 may generate several different versions of video streams for each source video to create an ABR ladder for the source video 102. For example, different versions of video streams for each source video 102 may vary by encoding bitrate, by picture resolution of the source video 102 (e.g., the source video 102 may be downsampled or upsampled prior to encoding), by frame rate of the source video 102, or by any combination of encoding bitrate, picture resolution, and frame rate. The recipient device 106 is depicted as a smart TV in FIG. 1, and although only the one recipient device 106 is shown, the streaming server 104 may stream the source video to any number of other recipient devices (e.g., the recipient devices 1004, 1006, 1008 of FIG. 10).

In the first part of the process 100, the streaming server 104 analyzes and encodes the source video 102 to generate the encoded video stream 118 and a streaming manifest. This part of the process 100 may be an ongoing part as the streaming server 104 begins communicating the encoded video stream 118 to the recipient device 106. During analysis of the source video 102, the streaming server monitors the source video 102 to determine a complexity metric for each scene 102, 112, 114, 116 of the source video 102. During this part of the process 100, the streaming server 104 may distinguish one scene 102, 112, 114, 116 from the next based on the determined complexity metrics, as opposed to distinguishing one scene from the next based on the content of the source video 102, metadata associated with the source video 1-2, or on any other factor or parameter other than the determined complexity metrics. In some embodiments, the streaming server may use factors or parameters in addition to the determined complexity metrics to distinguish one scene from the next scene. Thus, as shown, scene S1 110 and scene S3 114 may have a lower complexity metric than scene S2 112. By way of example, these differences in the respective complexity metrics may be the result of scene S1 110 and scene S3 114 featuring a sports news anchor sitting at a desk and talking about a sporting event, while scene S2 112 features a video clip of the sporting event itself (e.g., basketball, rugby, an auto race, etc.) Since scene S1 110 and scene S3 114 show the sports news anchor talking from a news desk, the changes between one frame of the source video 102 to the next frame may not be significant, and thus the streaming server 104 may determine that the complexity metrics for each of scene S1 110 and scene S3 114 are low scalar numbers. In comparison, since scene S2 112 shows the sporting event itself, with fast moving players or vehicles, the streaming server 104 may determine that the complexity metric for scene S2 112 is a high scalar number.

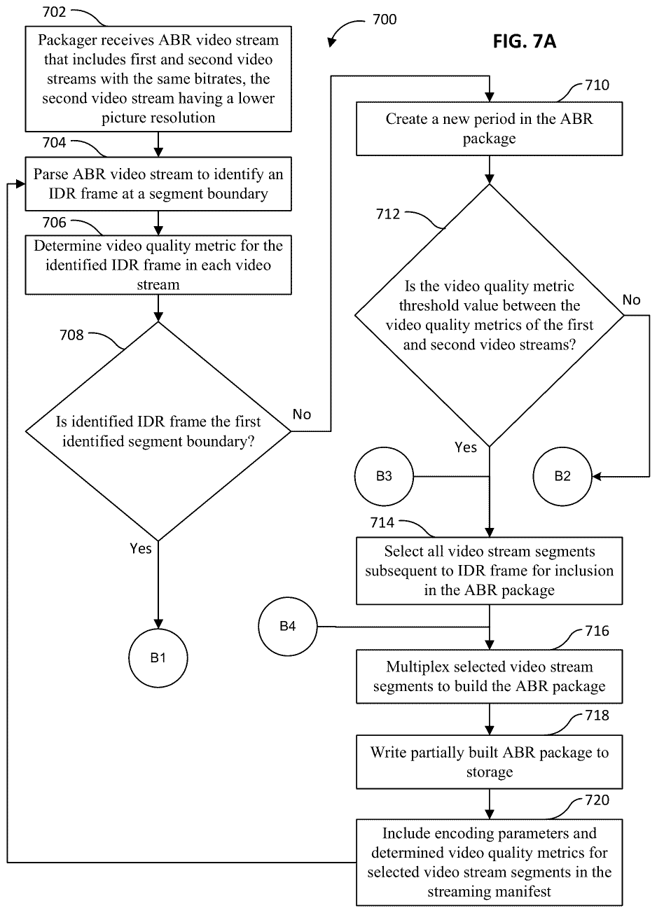

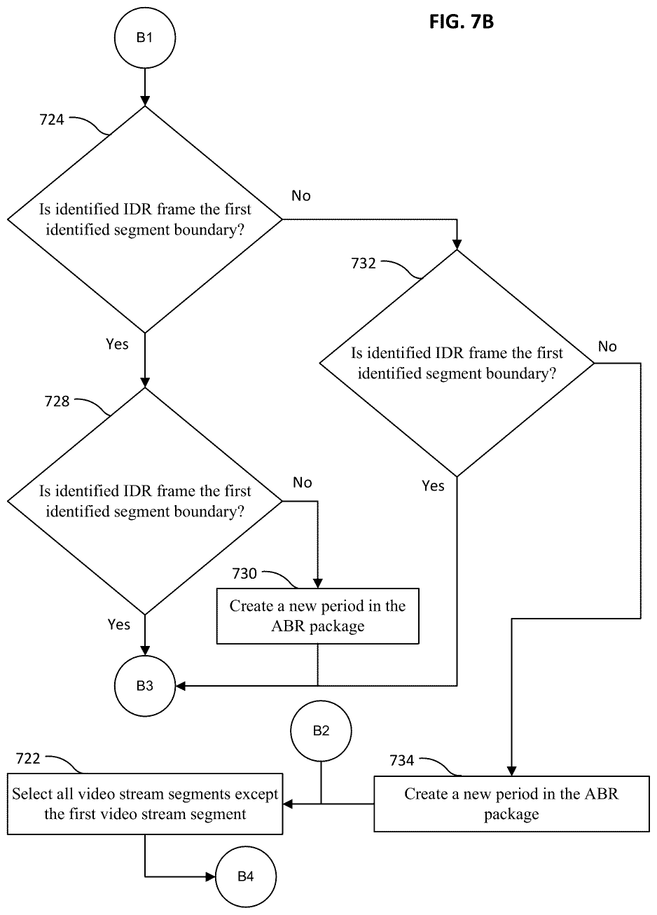

The streaming server 104 may further determine that these differences in the respective complexity metrics, based on comparison with a complexity metric threshold, warrant use of a first encoding scheme for scene S1 110 and scene S3 114 and use of a second encoding scheme for scene S2 112. These different encoding schemes are shown in the representation of the encoded video stream 118. In the encoded video stream 118, scene ES1 120 and scene ES3 124 are based on the source video at 1080p picture resolution and encoded at a bitrate of 10 Mbps. In comparison, scene ES2 122 is based on the source video at 720p picture resolution and encoded at a bitrate of 10 Mbps. After encoding each scene 120, 122, 124 of the video stream 118, the streaming server 104 determines a video quality metric for each scene 120, 122, 124. In some embodiments, the video quality metric may be a calculation based on parameters, metadata, and/or information known about the media content of the scene. The streaming server 104 may then build the streaming manifest by including information about the video stream 118 and the determined video quality metrics for each scene 120, 122, 124. The streaming server repeats this process while encoding each video stream to be included as part of the ABR ladder for the source video 102. During the encoding process for the video stream 118, if the streaming server 104 determines that a subsequent scene has a different encoding scheme as compared to an immediately previous scene (e.g., scene ES2 122 has a different encoding scheme as compared to scene ES1 120), then the streaming server updates the streaming manifest to reflect the change. Such updates are discussed in further detail herein (see FIGS. 7-9). In some embodiments, the streaming server 104 may communicate to the receiving device 106 only those portions of the streaming manifest that have been updated.

The streaming server 104 may receive either a streaming request or a streaming manifest request 128 from the recipient device 106. The streaming request may be received when the recipient device 106 makes the initial request for the video stream 118. Upon the initial request, the streaming server 104 communicates the video stream and the streaming manifest 126. The streaming manifest request may be received when the recipient device 106 receives a notification from the streaming server 104 that an update to the streaming manifest is available. In such circumstances, the recipient device 106 may request the updated streaming manifest and may use the updated streaming manifest to determine, based on the video quality metrics included in the streaming manifest, if a different video stream from the ABR ladder would provide a better picture quality when displayed on the recipient device 106. The recipient device 106 may therefore, in response to the updated streaming manifest, request and switch to a different video stream from the ABR ladder for the source video 102.

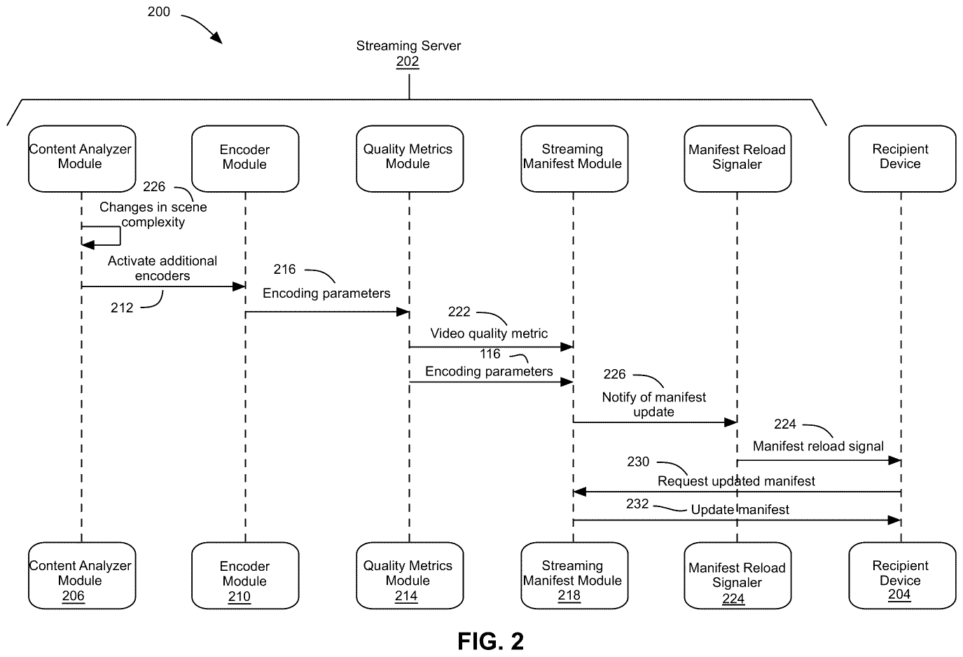

FIG. 2 is a sequence diagram illustrating a sequence 200 of steps that may be used to dynamically adjust schemes for encoding live video streams based on the complexity of scenes in the source video. Each of the steps in the sequence 200 labeled as part of the streaming server 202 may be implemented using the streaming system discussed herein. As part of the sequence 200, the streaming server 202 communicates with the recipient device 204 to indicate that the streaming manifest has been updated. For the streaming server 202, updates to the streaming manifest reflect the underlying dynamic adjustments to the encoding scheme that occur with respect to a live video stream being transmitted to the recipient device 204. In particular, the dynamic adjustments may be based on changes to the complexity of scenes within the source video. The sequence 200 for dynamic adjustments and communicating those dynamic adjustments to the recipient device 204, starts with the content analyzer module 206, which analyzes the source video to identify scenes that exhibit complexity in excess of a complexity threshold. In some embodiments, the content analyzer may evaluate the complexity of scenes within the source video in real-time. As part of analyzing scenes in the source video, the content analyzer module 206 determines a complexity metric for scenes, or sections of scenes, within the source video. The complexity metric may then be compared to a complexity metric threshold so that the content analyzer module 206 can detect changes in complexity and determine if a scene has sufficient complexity to warrant encoding the source video at a different bitrate.

Upon detection of a scene that has a complexity metric exceeding the complexity metric threshold, the content analyzer module 206 instructs the encoder module 210 to activate additional encoders 212. The encoder module 210 includes multiple encoders for encoding video streams, such that the encoder module 210 may encode video streams at several bitrates to generate video streams having several bitrates and a single picture resolution. The encoder module 210 may also activate (or deactivate) encoders as needed to generate video streams at different bitrates and/or at different picture resolutions. In general, video that exhibits a low amount of change from frame to frame is considered to have a low complexity, and video that exhibits a high amount of change from frame to frame is considered to have a high complexity. Complexity in a video may be measured by comparing changes in adjacent frames of the video. The comparison of adjacent frames may be performed using image comparison tools, statistical analysis, and/or machine learning models.

In some embodiments, scene complexity may be determined using a collection of bitrates, quantization parameters, picture resolution, frame rate, and the like, of the source video. One or more of these quantifications may be determined at the time the source video is ingested prior to encoding. In some embodiments, scene complexity may be determined from spatial and/or temporal complexity of one or more frames within the source video. In some embodiments, motion estimation techniques from video encoding standards or as employed in AI video analysis models may be used to detect motion levels, and therefore scene complexity. In some embodiments, methods such as the sum of absolute differences of the sum of absolute transformed differences may be utilized to gauge the overall motion activity in a video scene or segment. Some tools may include, e.g., MSU Video Quality Measurement Tool (VQMT), FFmpeg Quality Metrics, Video Quality Monitor (VQM) from AccepTV, SITI (Spatial Information/Temporal Information), Hybrik's Video Complexity Analysis, and/or VMAF. In some embodiments, tools such as an image difference function may be used to compare changes between two adjacent frames. Such methods may provide a quick and efficient way to estimate motion, and thus complexity, without requiring complex computations. In some embodiments, image comparison techniques may be used and implemented using, e.g., statistical analysis. Measurements indicating changes between adjacent frames, regardless of the tool used to measure the changes, may be considered one or more indicators of video complexity.

The encoder module 210, once instructed to activate additional encoding modules 212, proceeds to activate one or more additional encoders to encode the source video using the same bitrate but with a lower picture resolution for the source video. This encoding is performed in addition to the encoding already being performed by the encoder module 210 to generate the ABR ladder for the source video. Similarly, after a scene with additional complexity has been encoded, the encoder module 210 may deactivate encoders as needed.

As is discussed herein, by encoding a lower resolution of the source video, coding artifacts from encoding the source video at a high resolution may be reduced or eliminated. Once the encoder module 210 has determined the encoding parameters for the video stream, the encoder module 210 communicates the encoding parameters 216 to the quality metrics module 214. In some embodiments, encoding parameters may include, for each video stream generated, an identification, an estimated bandwidth for communicating each video stream, the bitrate, the picture resolution, and the codec used to encode each video stream. Additional information about the source video may also be included in the encoding parameters. Receipt of the encoding parameters 216 serves as a signal for the quality metrics module 214 to determine the video quality metric 222 for the requested encoded live video stream. After the video quality metric 222 is determined, the quality metrics module 214 communicates the encoding parameters 216 and the video quality metric 222 to the streaming manifest module 218. The streaming manifest module 218 updates the streaming manifest to incorporate the encoding parameters 216 and the video quality metric 222, and then a manifest update notification 226 is communicated to the manifest reload signaler 224. The manifest reload signaler 224 plays the role of communicating a manifest reload signal 228 to the recipient device 204. Following receipt of the manifest reload signal 228, the recipient device 204 may communicate a request for the updated manifest 230 to the streaming manifest module 218. And the streaming manifest module 218, after receiving the request for the updated manifest 230, communicates the updated manifest 232 to the recipient device 204. Through this process 200, the recipient device may generally maintain the most current version of the streaming manifest, thereby enabling the recipient device 204 to optimize the video quality of the source video displayed on recipient device 204.

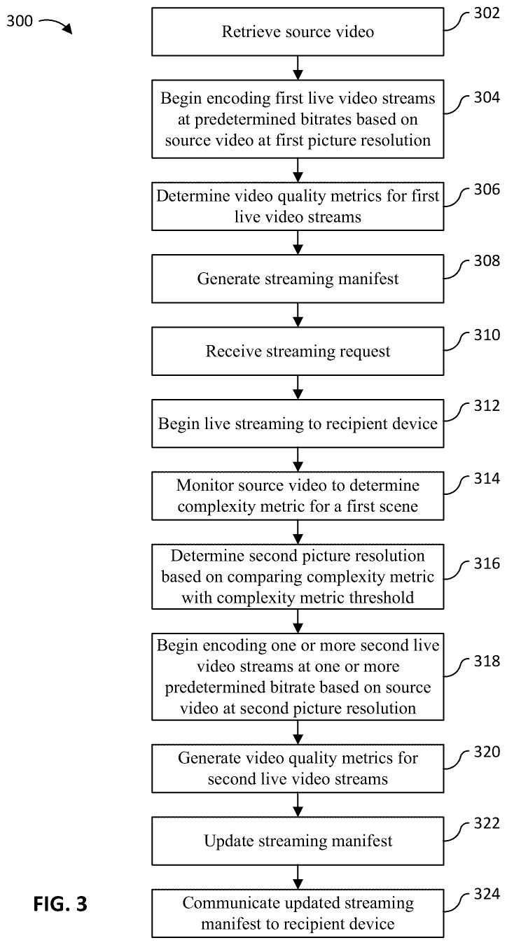

FIG. 3 shows a flowchart illustrating the steps of an exemplary process of dynamically adjusting schemes for encoding live video streams based on the complexity of scenes in the source video. The process 300 may be implemented on systems that are used for streaming video as discussed herein. One or more actions of the process 300 may be incorporated into or combined with one or more actions of any other process or embodiment described herein. For purposes of clarity, this process 300 is described in the context of being implemented on the streaming system 1002 shown in FIG. 10. In addition, one or more steps of the process 300 may be executed using distributed computing techniques, such that steps of the process 300 may be executed by control circuitry incorporated into other servers, cloud services, and/or other computing devices, each of which would then form a part of a streaming system.

At step 302, the streaming server retrieves the source video from a storage location or obtains the source video from a live recording source. The storage location may be local to the streaming server, or it may be remote from the streaming server, such as at a media source which is accessible through a wide area network such as the Internet. At step 304, the streaming server begins encoding the first live video streams at predetermined bitrates, using the source video at the first picture resolution. The first picture resolution may be any picture resolution the streaming server determines is appropriate under the streaming conditions at the time of encoding. At step 306, the streaming server determines video quality metric for the first live video streams, and at step 308, the streaming server generates the streaming manifest, which includes encoding parameters and video quality metrics for the first live video streams. At step 310, the streaming server receives a streaming request for the source video from a recipient device, and at step 312, the streaming server begins live streaming one of the live video streams to the recipient device. As part of step 312, when initiating the live streaming, the streaming server also communicates the streaming manifest to the recipient device. At step 314, the streaming server monitors the source video to determine a complexity metric for a first scene of the source video. The complexity metric, as described herein, may be any mathematical or other numerical descriptor which approximates the complexity of any frame, fragment, or segment of the source video. For example, the complexity metric may compare differences in the pixels between frames using a difference checker algorithm. The complexity metric may also be an average or median across frames, fragments, segments, or scenes within the source video. These examples for determining the complexity are intended to illustrative and non-limiting.

At step 316, the streaming server determines the second picture resolution based on comparing the complexity metric determined at step 314 with a complexity metric threshold. The value of the complexity metric threshold may be set based on the nature of the source video, the nature of a scene within the source video, or on any other appropriate basis which is deemed to improve the perceptual quality of the resulting live video stream on a recipient device. At step 318, the streaming server begins encoding one or more second live video streams at one or more predetermined bitrate based on the source video at the second picture resolution determined at step 316. For some source videos, only one second live video stream may be needed to help improve the quality of the video displayed on a recipient device. However, in some circumstances, or for some source videos, display quality improvements may be realized on different types of recipient devices by encoding more than one second live video stream. At step 320, the streaming server determines video quality metrics for each second live video stream that is encoded at step 318. In some embodiments the video quality metric may be determined by calculating a distortion metric, D, for each frame in each live video stream using the following formula:

$$D = \frac{{QP}^{α}}{{Resolution}^{β}} ,$$

Where QP is the quantization parameter for the IDR frame, Resolution is the number of pixels in the frame, α is a scalar parameter for adjusting the sensitivity to quantization, and β is a scalar parameter for adjusting defining the sensitivity to resolution. The scalar parameters may be optimized for different categorizations of videos or scenes within videos through regression or formula fitting. In some embodiments, α=3 may be used to heighten the sensitivity of the distortion metric to quantization, and β=0.5 may be used to lower the sensitivity of the distortion metric to picture resolution. Based on the above formula, the higher the distortion metric, D, the better the live video stream should perceptually appear on the recipient device. Thus, when the recipient device receives an updated streaming manifest, the recipient device may evaluate the distortion metric, D, to help evaluate which of the live video streams for the source video would present the best viewing experience for the user on the recipient device. Oftentimes, this evaluation may result in the recipient device selecting the live video stream with the lowest distortion metric, D.

As described above, the distortion metric does not require any information about the source videos themselves to be calculated. In some embodiments, the distortion metric may be calculated using functions other than the function described above. In some embodiments, information about the source video may be incorporated into the determination and/or calculation of the distortion metric.

At step 322, the streaming server updates the streaming manifest associated with the source video, and at step 324 the streaming server communicates to the recipient device a manifest reload signal, which indicates to the recipient device that the updated streaming manifest is available and should be reloaded. Once the recipient device is informed that the updated streaming manifest is available, the recipient device may request the updated streaming manifest from the streaming server. In some embodiments, the streaming server may push the updated streaming manifest out to the recipient device. In some embodiments, the streaming server may include a signal within the streaming manifest to inform the recipient device that the streaming manifest should be updated at predetermined periodic intervals. In practice, the manner in which the recipient device is instructed to request the streaming manifest, whether updated or not, may be highly dependent on the streaming protocol used by the streaming server. In some embodiments, the streaming server may communicate only the updated portions of the streaming manifest to the receiving device.

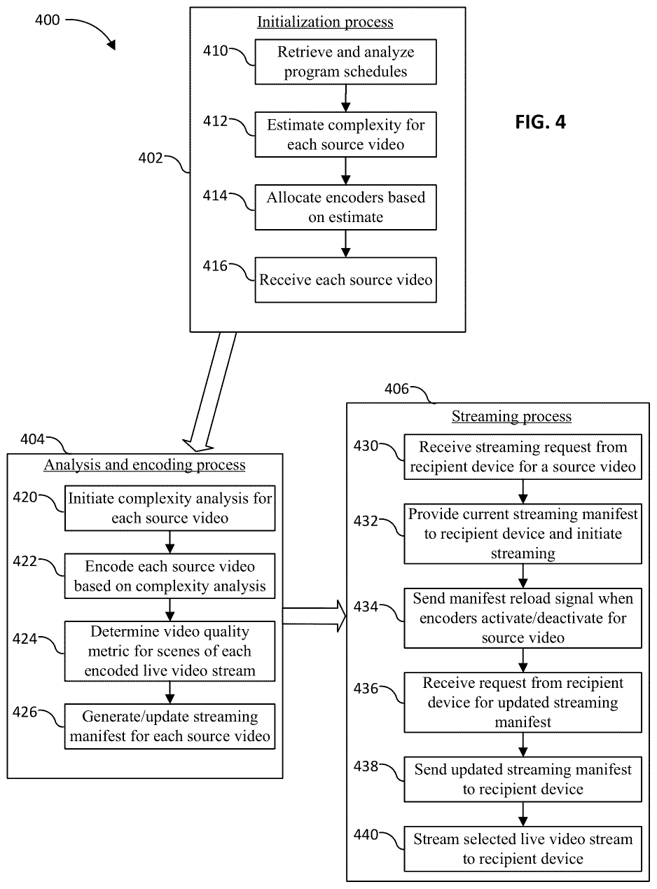

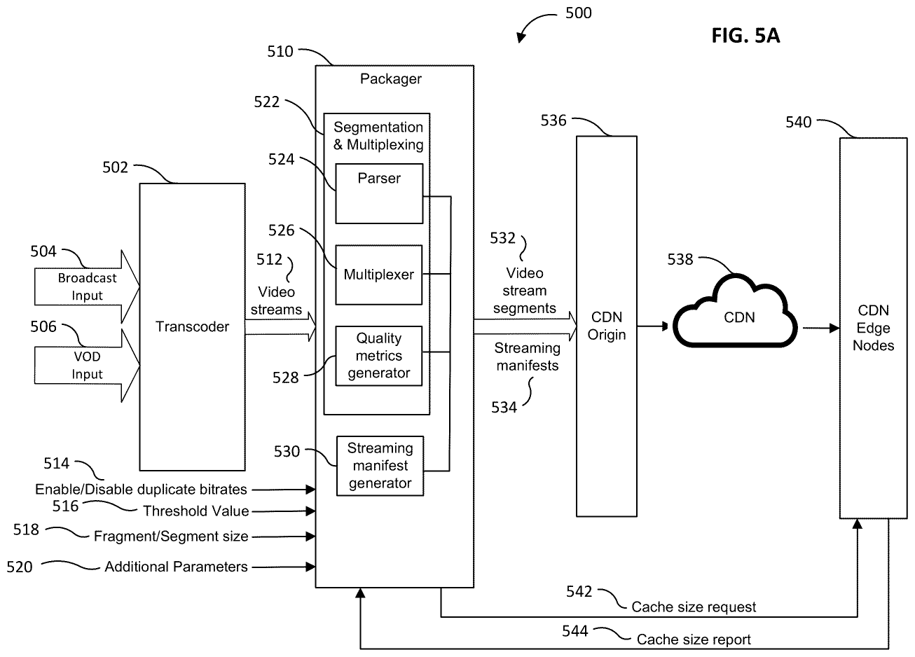

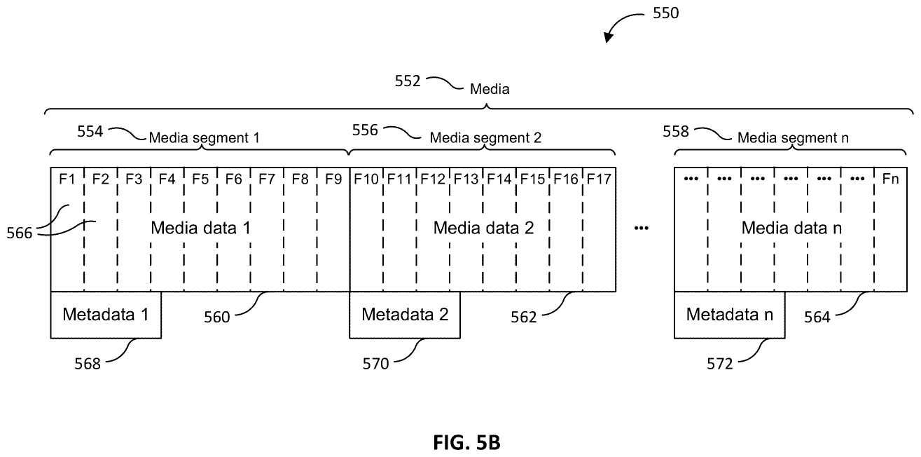

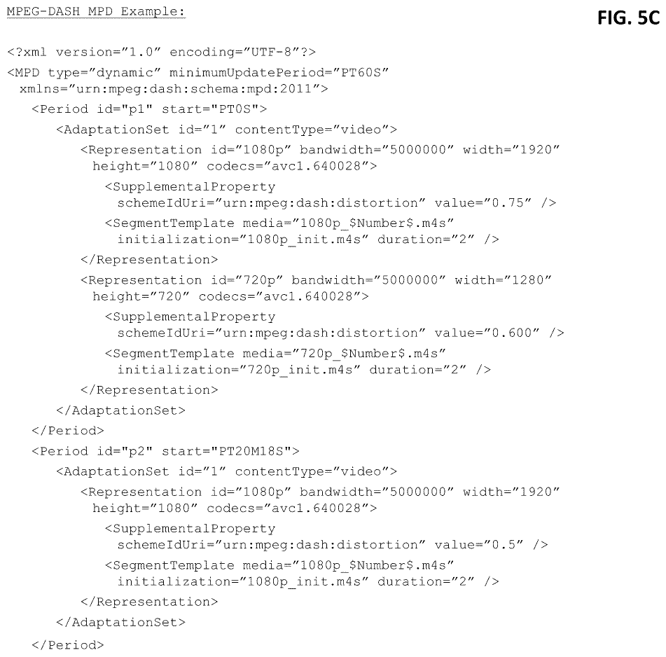

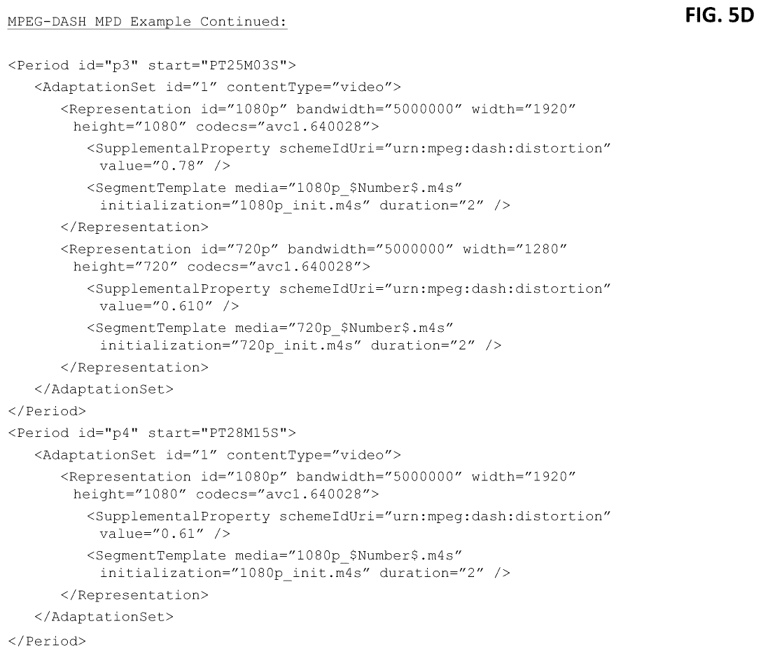

FIG. 4 shows a flowchart illustrating the steps of an exemplary process 400 of dynamically adjusting resources for encoding live video streams based on the complexity of scenes in the source video. The process 400 may be implemented on systems that are used for streaming video as discussed herein. One or more actions of the process 400 may be incorporated into or combined with one or more actions of any other process or embodiment described herein. For purposes of clarity, this process 400 is described in the context of being implemented on the streaming system 500 shown in FIG. 5A. In addition, one or more steps of the process 400 may be executed using distributed computing techniques, such that steps of the process 400 may be executed by control circuitry incorporated into other servers, cloud services, and/or other computing devices, each of which would then form a part of a streaming system.

The process 400 includes three sub-processes which are used for each source video that is to be streamed. These sub-processes are the initialization sub-process 402, the analysis and encoding sub-process 404, and the streaming sub-process 406. The initialization sub-process 402 is the part of the process 400 that identifies source videos that are to be streamed and preemptively establishes anticipated parameters for processing the source videos for streaming. The analysis and encoding sub-process 404 analyzes the source videos to determine if dynamic adjustments need to be made to the encoding scheme and processes the source videos to begin streaming. The streaming sub-process 406 performs streaming for each of the source videos and communicates with recipient devices if dynamic adjustments are made to the encoding scheme for any of the source videos.

Turning to the sub-processes in greater detail, the initialization sub-process 402 begins with retrieving and analyzing program schedules 410 to determine the source videos that are to be streamed, when the source videos are to be streamed, and what other source videos, regardless of where they are retrieved from, are to be streamed during overlapping times. Through this analysis, the initialization sub-process 402 may generate an electronic program guide (EPG), which may serve as a map showing when various source videos are to be streamed. The program schedules may be retrieved from a broadcaster who may be streaming video streams from multiple source videos at the same time to different recipient devices (e.g., smart phones, smart TVs, laptop computers, tablet computers, and the like). Having retrieved the program schedules 410, at step 412, the complexity for each source video is estimated. In some embodiments, this complexity estimate may be performed using predictive analytics, which may use machine learning algorithms to predict motion activity levels in different scenes of a source video based on historical data and program types. In some embodiments, the source videos may be retrieved with associated metadata that aids in making the complexity estimate for each source video. The estimated complexity from step 412 determines the encoding scheme selected for the ABR ladder that is used to encode the source video.

At step 414, encoders are allocated based on the complexity estimate and the selected encoding scheme for the ABR ladder. The allocated encoders are used to encode source videos to generate the live video streams for each source video. Also, as part of the initialization sub-process 402, at step 416 the source videos are received from a media provider. In some embodiments, the media provider may be a broadcast provider, which may be providing source videos for streaming simultaneously with the over-the-air broadcast of the source videos. In some embodiments, the media provider may be a creator of video-on-demand (VOD) media, and multiple VOD source videos may be provided to the streaming system for on-demand streaming.

At step 420, which is included as part of the analysis and encoding sub-process 404, a complexity analysis is initiated on each source video to determine the complexity of the beginning of the source video. Based on the estimated complexity of step 412 and this initial complexity analysis, at step 422, encoding for each source video begins. At this stage of the process 400, the encoding scheme for each source may be based on the selected encoding scheme for the ABR ladder. However, the selected encoding scheme may be modified if a comparison between the complexity metric for a scene of the source video and the complexity metric threshold (see steps 314-318 of FIG. 3) indicates that a dynamic adjustment should be made to the encoding scheme. At step 424, a video quality metric is determined for each scene in the encoded live video streams, and at step 426, the streaming manifest is initially generated and then updated as dynamic adjustments are made to the encoding scheme for a source video.

At step 430, which is included as part of the streaming sub-process 406, a streaming request is received from a recipient device for one of the source videos. At step 432, the current streaming manifest is provided to the requesting recipient device and streaming is initiated. At step 434, when there is a dynamic adjustment to the encoding scheme for a source video, a manifest reload signal is sent to recipient devices receiving streaming of the source video. Upon receipt of the streaming manifest reload signal, a recipient device may request the updated streaming manifest. At step 436, a request for the updated streaming manifest is received from a recipient device, and at step 438, the updated streaming manifest is sent to the requesting recipient device. As indicated herein, in some embodiments, the updated streaming manifest may be pushed out to the recipient device following the update. In some embodiments, the streaming manifest may include a signal to inform the recipient device that the streaming manifest should be updated at predetermined periodic intervals. At step 440, the live video stream selected by the recipient device is streamed to the recipient device. The live video stream may be the same live video stream selected by the recipient device at the initiation of streaming, or it may be a different a live video stream (based on the same source video) selected from an updated streaming manifest.

FIG. 5A shows a streaming system 500 in the form of a video on demand packager and a CDN. This system 500 supports dynamically adjusting encoding schemes, which helps to optimize the display of streaming videos on recipient devices and to optimize resources associated with and streaming live video streams. As shown, the streaming system includes several different computing platforms, each adapted to perform specific tasks within the streaming system 500. This streaming system 500 is configured to efficiently manage ABR package creation across multiple channels by incorporating predictive analytics and dynamic resource allocation as discussed herein. In some embodiments, other metrics could be leveraged to aid in package creation and the allocation of resources. The streaming system 500 helps ensure high quality streaming for video content that includes high-motion scenes while also optimizing available network resources and maintaining consistent bitrate management.

The streaming system 500 receives source videos at the transcoder 502. As shown, the video input to the transcoder is in the form of broadcast input 504, which may include live video and audio, and VOD (Video on Demand) input 506. The streaming system 500 as shown may serve as both of a CMAF (Common Media Application Format) Live packager and VOD packager. The transcoder 502 may upsample and/or downsample source videos prior to encoding. The transcoder 502 assigns encoding resources to each received source video to generate an ABR ladder that meets the needs of the intended distribution. As is typical, the ABR ladder generated for a source video includes video streams encoded at several predetermined bitrates, and each video stream has a predetermined video resolution. As resources are available, however, the transcoder 502 may generate additional video streams at bitrates that already exist within the ABR ladder but having a different video resolution than the video stream with the predetermined video resolution. The additional video streams may be used to provide an enhanced viewing experience by improving the quality of the displayed video on the recipient device. The streaming system 502 may generate the ABR package in any format appropriate for video streaming, such as HTTP Live Streaming (HLS), Dynamic Adaptive Streaming over HTTP (DASH), Microsoft Smooth Streaming (MSS), and Adobe HTTP Dynamic Streaming (HDS), or any other type of video streaming format.

By way of example, the transcoder 502 may generate an ABR ladder to include video streams at the following bitrates and picture resolutions: a 4K picture resolution with a bitrate of 10 Mbps; a 1080p picture resolution with a bitrate of 8 Mbps; a 1080p picture resolution with a bitrate of 6 Mbps; and a 720p picture resolution with a bitrate of 5 Mbps. To this ABR ladder, the transcoder 502 may also generate duplicate bitrate video streams at 1080p at 10 Mbps and at 720p at 8 Mbps. The packager 510 receives from the transcoder 502 packetized elementary streams (PES) of the video streams 512 being encoded, along with the quantization parameters (QP) used for the encoding. The packager 510 may also receive other data that is used for parsing and multiplexing the video streams, including toggle bit for enabling/disabling duplicate bitrates 514, a video quality threshold value 516, an indicator of the fragment size (which may be used with the CMAF format) or the segment size (which may be used with the VOD or CMAF Live format), and any additional parameters that may be used by the packager 510.

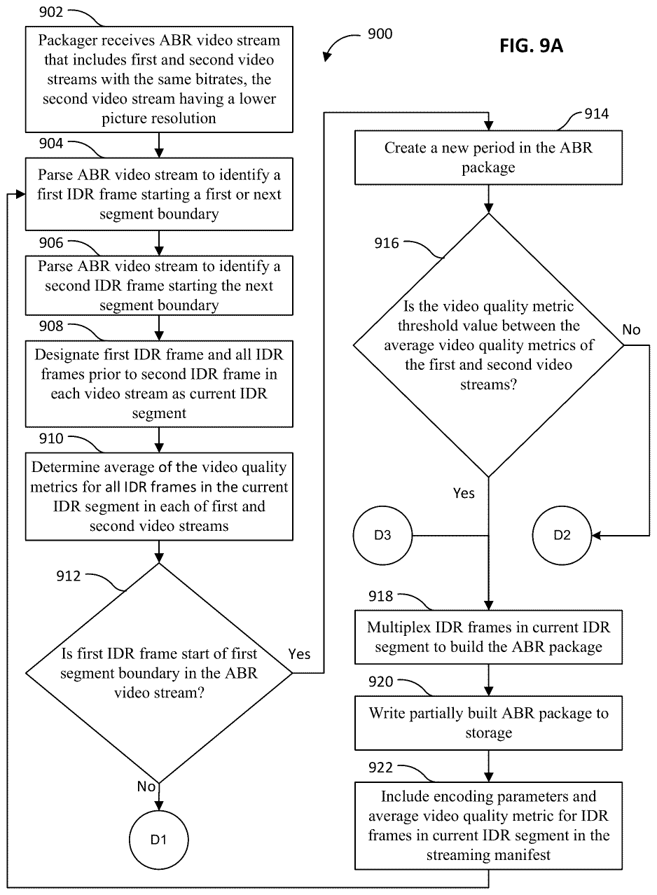

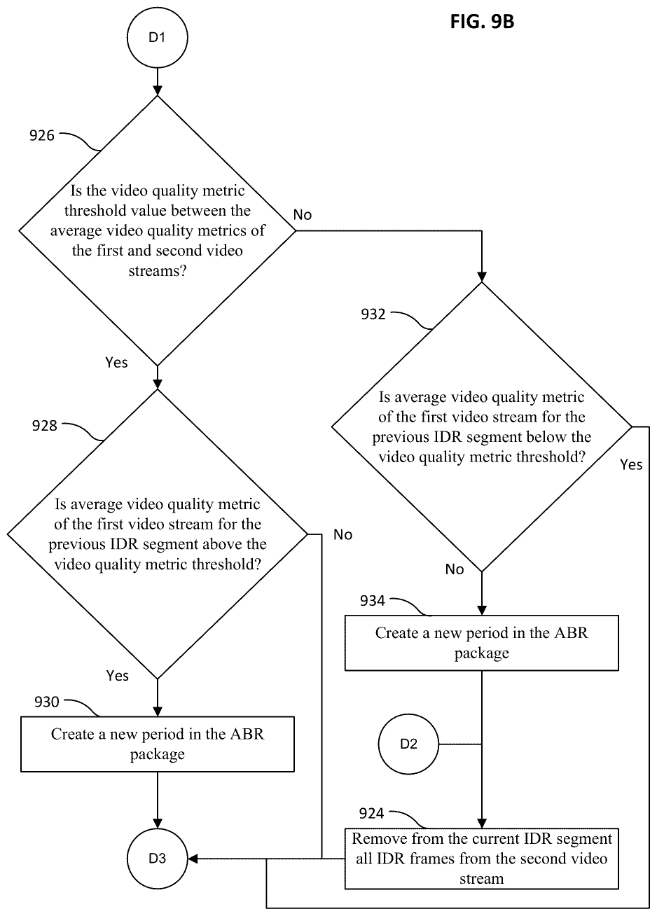

The packager 510 includes a segmentation and multiplexing sub-system 522, which includes the parser 524, the multiplexer 526, and the quality metrics generator 528. The segmentation and multiplexing sub-system 522 receives the PES of the video streams 512 and parses them within the parser 524. The parser 524 also simultaneously parses the quantization parameters and utilizes the parsed data to identify IDR frames and segments within the video streams 512. In some embodiments, the parser 524 may utilize the parsed data to identify IDR frames and fragments within the video streams 512 (see, e.g., FIG. 9). The QP may be further used to calculate the video quality metric by the quality metrics generator 528. In some embodiments, the QP of an entire segment or fragment may be used to calculate the video quality metric. In such embodiments, the QP of the IDR frame at the start of the segment or fragment may be used to represent the QP of the segment when calculating the video quality metric. In some embodiments, the video quality metric may be calculated in the same matter described above in relation to FIG. 3.

FIG. 5B illustrates an exemplary media segmentation 550 along with the associated metadata. As shown, the media 552 includes three media segments 554, 556, 558. Each media segment 554, 556, 558 includes media data 560, 562, 564, the which is displayed as the media content on the recipient device. Each media segment 554, 556, 558 also includes a plurality of frames 566 (labeled as F1, F2, . . . Fn). The first frame in each media segment 554, 556, 558 is the IDR frame (e.g., F1, F10). The media 552 may also include metadata 568, 570, 572. All video streams and/or video stream formats may not include the same type, amount, or character of data within the metadata 568, 570, 572. For example, if the media 552 does not include any segmentation, the media 552 may include only metadata 568 (referred to as “moov” within some formats) associated with the beginning of the media 552. As another example, if the media 552 is segmented, then each metadata 570, 572 (referred to as “moof” within some formats) may include information about the associated media segment 556, 558, while the metadata 568 may include information about the associated media segment 554 and about the media 552.

Returning to FIG. 5A, the calculated video quality metric for each segment is inserted into the streaming manifest as the streaming manifest is generated by the streaming manifest generator 530. FIGS. 5C-D show an abbreviated example of a streaming manifest which includes video quality metrics associated with each identified segment and multiple picture resolution options for streaming some segments at the same bitrate. The determination of which segments include multiple picture resolution options for streaming is based on the video quality metrics of segments located at the same timecode within the video stream in comparison to the video quality metric threshold. In some embodiments, the difference between the video quality segments may be determined and that difference compared with the video quality metric threshold. If the difference is above the threshold, then the multiplexer 526 may include segments from both video streams in the generated package. In general, a higher video quality threshold may be used to conserve storage space at the CDN (content delivery network) origin 536, within the CDN network 538, and at the CDN edge nodes 540. The packager 510 may determine how much storage is available at the CDN edge nodes 540 by communicating a cache size request 542 to the CDN edge nodes 540. In response to a cache size request 542, the CDN edge nodes 540 communicate a cache size report 54 to the packager 510. If the CDN edge nodes 540 available storage space is determined to be too limited, the packager 510 may stop producing the duplicate bitrate segments at the lower resolution. In some embodiments, the transcoder 502 may always encode the duplicate bitrate streams, and the packager 510 determines whether segments from the duplicate bitrate streams are produced to the content delivery network.

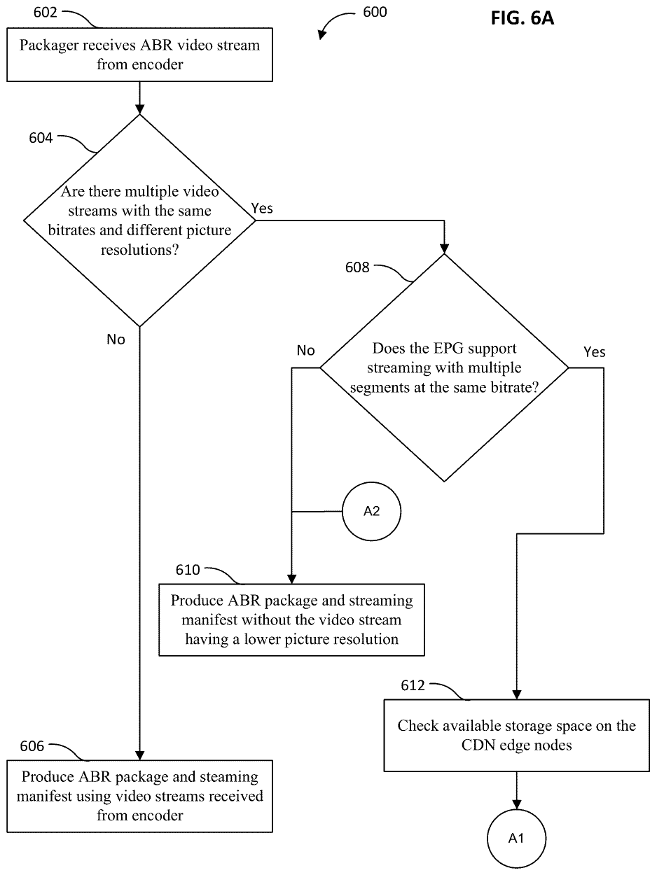

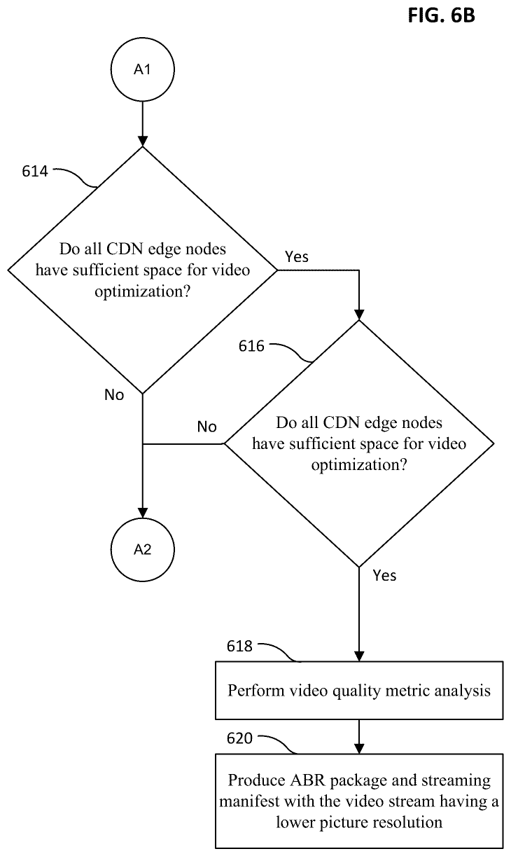

FIG. 6 shows a flowchart illustrating the steps of an exemplary process of determining whether an option for optimization is available and supported for live stream videos received from an encoder. The process 600 may be implemented on systems that are used for streaming video as discussed herein. One or more actions of the process 600 may be incorporated into or combined with one or more actions of any other process or embodiment described herein. For purposes of clarity, this process 600 is described in the context of being implemented on the streaming system 500 shown in FIG. 5A. In addition, one or more steps of the process 600 may be executed using distributed computing techniques, such that steps of the process 600 may be executed by control circuitry incorporated into other servers, cloud services, and/or other computing devices, each of which would then form a part of a streaming system.

At step 602, the packager receives an ABR video stream from an encoder module. The received ABR video stream, for purposes of this description, may include one or more video streams that are encoded at the same bitrate as another of the video streams, but with a different picture resolution. The received ABR video stream, therefore, may have been processed by both the initialization sub-process 402 and the analysis and encoding sub-process 404 of FIG. 4. At step 604, the packager determines if there are multiple video streams with the same bitrates and different picture resolutions. If there are not any video streams meeting the criteria stated in step 604, then at step 606 the packager produces an ABR package and streaming manifest using the video streams received from the encoder. If there are video streams meeting the criteria stated in step 604, then at step 608, the packager determines if the EPG supports streaming with multiple video streams having the same bitrate. If the EPG does not support streaming with multiple video streams having the same bitrate, then at step 610 the packager produces an ABR package and streaming manifest without the video stream having a lower picture resolution. If the EPG does support streaming with multiple video streams having the same bitrate, then at step 612 the packager checks for available storage space on the CDN edge nodes.

At step 614, the packager determines if all CDN edge nodes have sufficient space for the ABR package that includes at least one video stream that has the same bitrate as another of the video streams. If not all CDN edge nodes have sufficient space, then the process 600 returns to step 610, and the packager produces an ABR package and streaming manifest without the video stream having a lower picture resolution. If all CDN edge nodes have sufficient space, then at step 616 the packager determines if the type of video quality metric analysis needed to further process the video streams is supported by the packager. If the packager does not support the type of video quality metric analysis needed, then the process 600 returns to step 610, and the packager produces an ABR package and streaming manifest without the video stream having a lower picture resolution. If the packager does not support the type of video quality metric analysis needed, then at step 618 the packager performs the video quality metric analysis. At step 620, the packager produces an ABR package and streaming manifest with the video stream having a lower picture resolution. Three different types of support of performing the video quality metric analysis are discussed with respect to FIGS. 7-9.

FIG. 7 shows a flowchart illustrating the steps of a first exemplary process of analyzing live video streams to determine the video quality metric and packaging the live video streams for streaming. The process 700 may be implemented on systems that are used for streaming video as discussed herein. One or more actions of the process 700 may be incorporated into or combined with one or more actions of any other process or embodiment described herein. For purposes of clarity, this process 700 is described in the context of being implemented on the streaming system 500 shown in FIG. 5A. In addition, one or more steps of the process 700 may be executed using distributed computing techniques, such that steps of the process 700 may be executed by control circuitry incorporated into other servers, cloud services, and/or other computing devices, each of which would then form a part of a streaming system.

At step 702, the packager receives an ABR video stream that includes first and second video streams with the same bitrates, the second video stream having a lower picture resolution. At step 704, the packager parses the ABR video stream to identify an IDR frame at a segment boundary. This identified IDR frame is going to serve as a representation of the subsequent video segment during the process 700. At step 706, the packager determines the video quality metric for the identified IDR frame in each video stream included in the ABR package. At step 708, the packager confirms that the identified IDR frame is the first identified video segment boundary in the ABR package. If the identified IDR frame is the first identified video segment boundary, then at step 710 the packager creates a new period in the ABR package. At step 712, the packager determines if the video quality metric threshold value is between the video quality metrics of the first video stream and the second video stream. If the video quality metric threshold value is between the first and second video quality metrics, then at step 714 the packager selects all video segments subsequent to the IDR frame for inclusion in the ABR package. At step 716, the packager multiplexes the selected video segments to build the ABR package. At step 718, the packager writes the partially built ABR package to storage. The process 700 then returns to step 704.

If the video quality metric threshold value of step 712 is not between the first and second video quality metrics, then at step 722 the packager selects all video segments except the first video segment. Then at step 716, the packager multiplexes the selected video segments to build the ABR package. At step 718, the packager writes the partially built ABR package to storage. The process 700 then returns to step 704.

If the IDR frame identified at step 708 is not the first identified video segment boundary, then at step 724 the packager determines if the video quality metrics of the first and second video streams with a video quality metric threshold value. If the video quality metric threshold value is between the video quality metrics of the first and second video streams, then at step 728 the packager determines if the video quality metric of the first video stream for the previous boundary IDR frame was above the video quality metric threshold. If in step 728 the video quality metric was above the video quality threshold, then the process 700 proceeds to steps 714-720 and returns to step 704. If in step 728 the video quality metric was not above the video quality threshold, then at step 730 the packager creates a new period in the ABR package. The process 700 then proceeds to steps 714-720 and returns to step 704.

If, at step 724, the video quality metric threshold value is not between the video quality metrics for the first and second video streams, then at step 732 the packager determines if the video quality metric of the first video stream for the previous boundary IDR frame was below the video quality metric threshold. If in step 732 the video quality metric was below the video quality threshold, then the process 700 proceeds to steps 714-720 and returns to step 704. If in step 732 the video quality metric was not below the video quality threshold, then at step 734 the packager creates a new period in the ABR package. The process 700 then proceeds to step 722, from there to steps 716-720, and then returning to step 704.

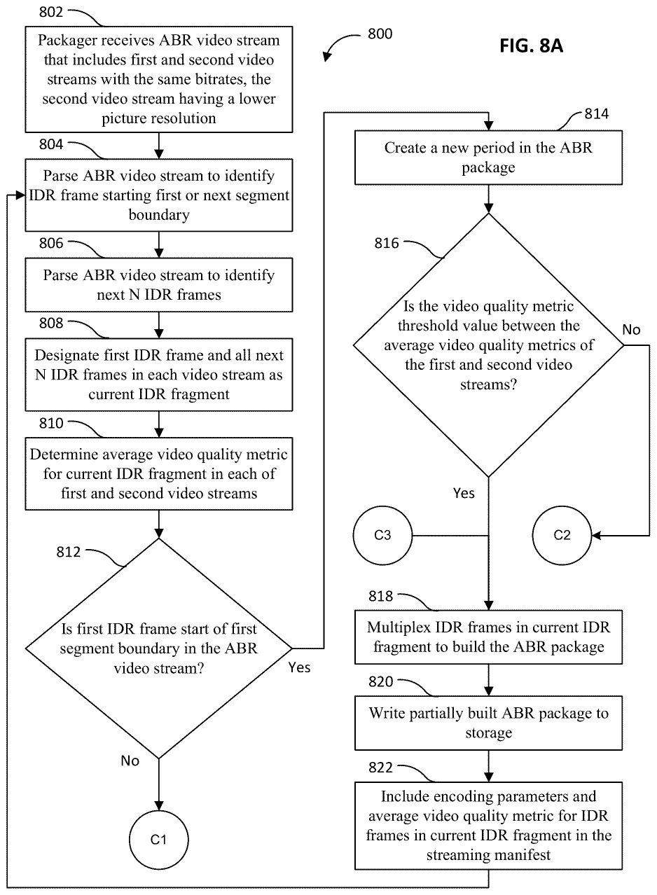

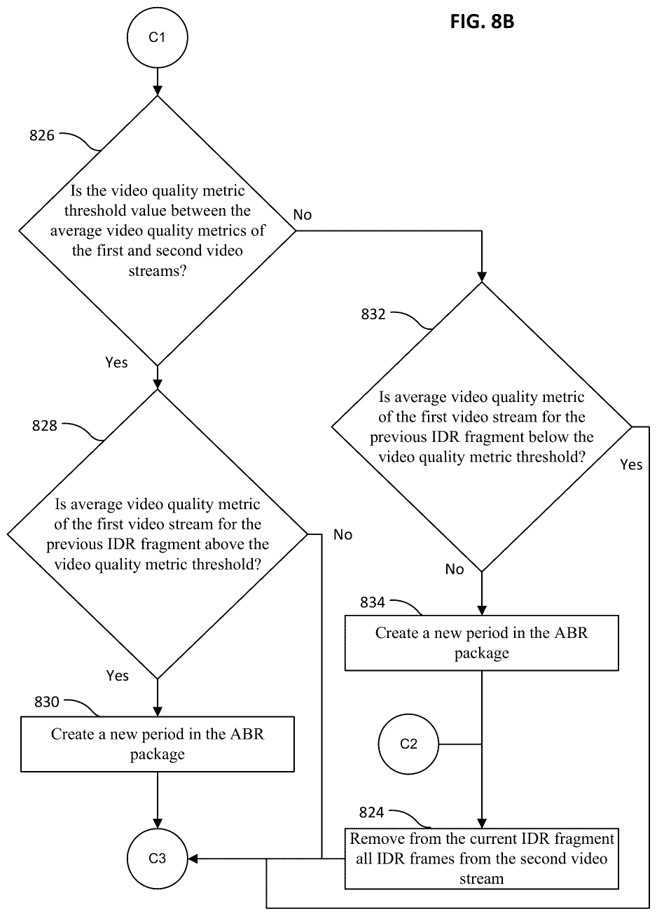

FIGS. 8A-B show a flowchart illustrating the steps of a second exemplary process of analyzing live video streams to determine the video quality metric and packaging the live video streams for streaming. The process 800 may be implemented on systems that are used for streaming video as discussed herein. One or more actions of the process 800 may be incorporated into or combined with one or more actions of any other process or embodiment described herein. For purposes of clarity, this process 800 is described in the context of being implemented on the streaming system 500 shown in FIG. 5A. In addition, one or more steps of the process 800 may be executed using distributed computing techniques, such that steps of the process 800 may be executed by control circuitry incorporated into other servers, cloud services, and/or other computing devices, each of which would then form a part of a streaming system.

At step 802, the packager receives an ABR video stream that includes first and second video streams with the same bitrates, the second video stream having a lower picture resolution. At step 804, the packager parses the ABR video stream to identify the IDR frame starting the first or next video segment boundary. At step 806, the packager parses the ABR video stream to identify the next N frames following the IDR frame identified at step 804, where N is predetermined and represents the sample size of the number of frames to be included in a video fragment. At step 808, the packager designates the first IDR frame and all frames prior to second IDR frame in each video stream as the current video fragment. At step 810, the packager determines the average of the video quality metrics for all IDR frames in the current video fragment in each of first and second video streams. At step 812, the packager confirms that the first IDR frame is the first identified video segment boundary in the ABR package. If the identified IDR frame is the first identified video segment boundary, then at step 814 the packager creates a new period in the ABR package. At step 816, the packager determines if the video quality metric threshold value is between the average video quality metrics of the first video stream and the second video stream. If the video quality metric threshold value is between the first and second average video quality metrics, then at step 818 the packager multiplexes the frames in the current video fragment to build the ABR package. At step 820, the packager writes the partially built ABR package to storage. The process 800 then returns to step 804.

If the video quality metric threshold value of step 816 is not between the first and second average video quality metrics, then at step 824 the packager removes from the current video fragment all frames from the second video stream. Next, at step 818, the packager multiplexes the frames in the current video fragment to build the ABR package. At step 820, the packager writes the partially built ABR package to storage. The process 800 then returns to step 804.

If the IDR frame identified at step 812 is not the first identified video segment boundary, then at step 826 the packager determines if the video quality metric threshold value is between the average video quality metrics of the first and second video streams. If the video quality metric threshold value is between the average video quality metrics of the first and second video streams, then at step 828 the packager determines if the average video quality metric of the first video stream for the previous video fragment was above the video quality metric threshold. If at step 828 the average video quality metric of the first video stream for the previous video fragment was above the video quality metric threshold, then the process 800 proceeds to steps 816-822 and returns to step 804. If at step 828 the average video quality metric was not above the video quality threshold, then at step 830 the packager creates a new period in the ABR package. The process 800 then proceeds to steps 818-822 and returns to step 804.

If, at step 826, the video quality metric threshold value is not between the average video quality metrics for the first and second video streams, then at step 832 the packager determines if the average video quality metric of the first video stream for the previous video fragment is below the video quality metric threshold. If in step 832 the average video quality metric is below the video quality threshold, then the process 800 proceeds through steps 818-822 and returns to step 804. If in step 832 the average video quality metric is not below the video quality threshold, then at step 834 the packager creates a new period in the ABR package. The process 800 then proceeds to step 824, from there through steps 818-822, and then returns to step 804.

FIGS. 9A-B shows a flowchart illustrating the steps of a third exemplary process of analyzing live video streams to determine the video quality metric and packaging the live video streams for streaming. The process 900 may be implemented on systems that are used for streaming video as discussed herein. One or more actions of the process 900 may be incorporated into or combined with one or more actions of any other process or embodiment described herein. For purposes of clarity, this process 900 is described in the context of being implemented on the streaming system 500 shown in FIG. 5A. In addition, one or more steps of the process 900 may be executed using distributed computing techniques, such that steps of the process 900 may be executed by control circuitry incorporated into other servers, cloud services, and/or other computing devices, each of which would then form a part of a streaming system.

At step 902, the packager receives an ABR video stream that includes first and second video streams with the same bitrates, the second video stream having a lower picture resolution. At step 904, the packager parses the ABR video stream to identify a first IDR frame starting a first or next video segment boundary. At step 906, the packager parses the ABR video stream to identify a second IDR frame starting the next video segment boundary. At step 908, the packager designates the first IDR frame and all frames prior to second IDR frame in each video stream as the current video segment. At step 910, the packager determines the average of the video quality metrics for all frames in the current video segment in each of first and second video streams. At step 912, the packager confirms that the first IDR frame is the first identified video segment boundary in the ABR package. If the identified IDR frame is the first identified video segment boundary, then at step 914 the packager creates a new period in the ABR package. At step 916, the packager determines if the video quality metric threshold value is between the average video quality metrics of the first video stream and the second video stream. If the video quality metric threshold value is between the first and second average video quality metrics, then at step 918 the packager multiplexes the frames in the current video segment to build the ABR package. At step 920, the packager writes the partially built ABR package to storage. The process 900 then returns to step 904.

If the video quality metric threshold value of step 916 is not between the first and second average video quality metrics, then at step 924 the packager removes from the current video segment all frames from the second video stream. Then at step 918, the packager multiplexes the frames in the current video segment to build the ABR package. At step 920, the packager writes the partially built ABR package to storage. The process 900 then returns to step 904.

If the IDR frame identified at step 912 is not the first identified video segment boundary, then at step 926 the packager determines if the video quality metric threshold value is between the average video quality metrics of the first and second video streams. If the video quality metric threshold value is between the average video quality metrics of the first and second video streams, then at step 928 the packager determines if the average video quality metric of the first video stream for the previous video segment was above the video quality metric threshold. If at step 928 the average video quality metric of the first video stream for the previous video segment was above the video quality metric threshold, then the process 900 proceeds to steps 916-922 and returns to step 904. If at step 928 the average video quality metric was not above the video quality threshold, then at step 930 the packager creates a new period in the ABR package. The process 900 then proceeds to steps 918-922 and returns to step 904.

If, at step 926, the video quality metric threshold value is not between the average video quality metrics for the first and second video streams, then at step 932 the packager determines if the average video quality metric of the first video stream for the previous video segment is below the video quality metric threshold. If in step 932 the average video quality metric is below the video quality threshold, then the process 900 proceeds through steps 918-922 and returns to step 904. If in step 932 the average video quality metric is not below the video quality threshold, then at step 934 the packager creates a new period in the ABR package. The process 900 then proceeds to step 924, from there through steps 918-922, and then returns to step 904.

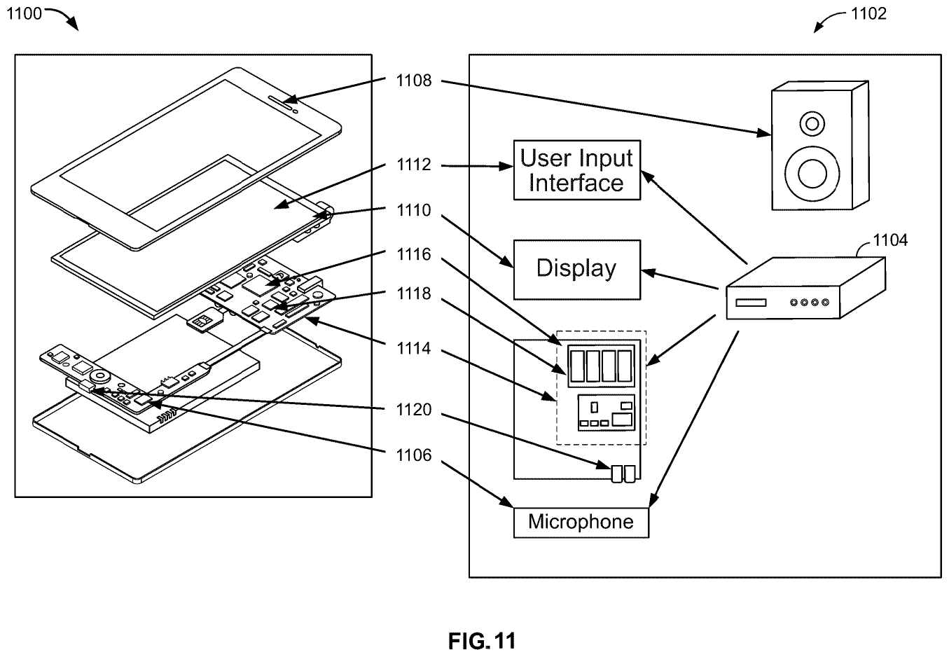

FIGS. 10-11 illustrate exemplary devices, systems, servers, and related hardware for streaming video, in accordance with some embodiments of the present disclosure. FIG. 10 is a diagram of an illustrative streaming system 1002 in communication with recipient devices 1004, 1006, 1008, in accordance with some embodiments of the disclosure. The streaming system 1002 and recipient devices 1004, 1006, 1008 are communicably coupled to a communication network 1010. The recipient devices 1004, 1006 1008 shown are intended to be non-limiting exemplary devices, and many other types of devices may be used as recipient devices (e.g., laptop computers, tablet computers, virtual reality head-mounted displays, and projection systems, among others. In some embodiments, the streaming system 1002 may take the form of the packager and content delivery network shown in FIG. 5A. As shown, the streaming system 1002 also includes a media content source 1012 and cloud services 1014 communicably coupled to the communication network 1010. The streaming system 1002 may also include additional streaming servers, streaming devices, media sources, cloud services, and/or recipient devices communicably coupled to a communication network 1010. In some embodiments, a recipient device may function as a streaming server to stream video to one or more other recipient devices coupled to the communication network 1010. Similarly, in some embodiments, a cloud service may function as a streaming server to stream video to one or more of the recipient devices. In some embodiments, cloud services may provide processing, sharing, storage, and/or distribution services to the streaming system 1002 and/or any of the recipient devices 1004, 1006, 1008. In some embodiments, the video streaming processes described herein may be executed at the control circuitry 1018 of the streaming system 1002 and/or control circuitry of other servers connected to the communication network 1010 and/or by control circuitry of cloud services connected to the communication network 1010.

As used herein, the terms “cloud”, “cloud services”, and other related terms refer to a cloud computing environment in which various types of computing services may perform functions as part of a distributed computing system in combination with the control circuitry of another computing device, such as the streaming system 1002 or any of the recipient devices 1004, 1006, 1008. The cloud computing environment may provide computing services such as database services, virtual computing services, storage services, services for generating video, services for encoding/decoding video, and/or services for processing, analyzing, or parsing data (e.g., using algorithms, which may include machine learning algorithms) by a collection of network-accessible computing and storage resources. For example, the streaming system 1002 may utilize machine learning algorithms to analyze image frame quality data as part of the process of dynamically adjusting picture resolution.

The communication network 1010 may be one or more networks including the Internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 1010) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications between the streaming system 1002 and the recipient devices 1004, 1006, 1008 may be provided by one or more of these communications paths, thereby forming a network connection, but are shown as a single path in FIG. 10 to avoid overcomplicating the drawing.

Although communications paths are not drawn between recipient devices 1004, 1006, 1008, the recipient devices 1004, 1006, 1008 may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communications via wired or wireless paths. The recipient devices may also communicate with each other directly through an indirect path via the communication network 1010.

As shown, the streaming system 1002 includes a database 1016, which may be used to store data associated with streaming videos. In some embodiments, the database 1016 may be used to manage, organize, and/or store source videos that may be streamed by the streaming system 1002. In such embodiments, source videos may be maintained at or otherwise associated with the streaming system 1002, and/or at the storage 1020, and/or at any other storage and/or at any other device having storage communicably coupled to the database 1016 via the communication network 1010. In some embodiments, the media content source 1012 and the streaming system 1002 may be integrated into one video source device.

Communications with the media content source 1012 and the streaming system 1002 may be exchanged over one or more communications paths but are shown as a single path in FIG. 10 to avoid overcomplicating the drawing. Also, additional media content sources and/or additional streaming servers may be incorporated into the streaming system 1002, but only one of each is shown in FIG. 10 to avoid overcomplicating the drawing.

The streaming system 1002 includes control circuitry 1018, a storage 1020 (e.g., RAM, ROM, Hard Disk, Removable Disk, etc.), and an input/output (I/O) path 1022. The I/O path 1022 may provide device information, or other data, over a local area network (LAN) or wide area network (WAN), and/or other content and data to the control circuitry 1018, which includes processing circuitry, and to the storage 1020. The control circuitry 1018 may be used to send and receive commands, requests, content, and other suitable data using the I/O path 1012, which may include I/O circuitry. The control circuitry 1018 may be instructed to perform all or any part of the functions discussed herein. The I/O path 1022 may connect the control circuitry 1018 (specifically, the processing circuitry) to one or more communications paths for communications with the communication network 1010 and other servers, services, and devices.

The control circuitry 1018 may include video encoding circuitry, such as one or more MPEG-2 encoders or any other encoding circuitry suitable for processing and encoding source video (e.g., over-the-air video, analog video, and/or digital video to MPEG encoded video for video streaming). The control circuitry 1018 may also include video decoding circuitry, such as one or more MPEG-2 decoders or any other circuitry suitable for decoding and processing encoded video. The control circuitry 1018 may also include scaler circuitry for upsampling and/or downsampling video into the preferred picture resolution format of a recipient device. The control circuitry 1018 may also include analog-to-digital converter circuitry and digital-to-analog converter circuitry for converting between digital and analog video signals. The encoding circuitry 1018 may be used by the streaming server to process, encode, decode, resample, and/or perform conversions of video as part of performing the processes and/or functions described herein in connection with FIGS. 1-9. The encoding circuitry described herein, including, for example, video generating, encoding, decoding, encrypting, decrypting, scaler, and analog/digital circuitry, may be implemented using software running on one or more general purpose or specialized processors. In some embodiments, the video encoding circuitry and/or the video decoding circuitry may be performed by other network-accessible systems and/or services (e.g., the media content source 1012 and cloud services 1014, among others).

The control circuitry 1018 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, the control circuitry 1018 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 1018 executes instructions for an emulation system application stored in memory (e.g., the storage 1020). Memory may be an electronic storage device provided as storage 1020 that is part of the streaming system 1002 In some embodiments, memory may be incorporated as part of the control circuitry 1018.

The streaming system 1002 may retrieve source video from storage 1020, the database 1016, or the media content source 1012, process the source video as is described in detail herein, and stream the processed source video to one or more of the recipient devices 1004, 1006, 1008. The media content source 1012 may include one or more types of content distribution equipment including a television distribution facility, cable system headend, satellite distribution facility, programming sources, intermediate distribution facilities and/or servers, Internet providers, on-demand media servers, and other content providers. The media content source 1012 may be the originator of content (e.g., a television broadcaster, a Webcast provider, etc.) or may not be the originator of content (e.g., an on-demand content provider, an Internet provider of content of broadcast programs for downloading, etc.). The Media content source 1012 may include cable sources, satellite providers, on-demand providers, Internet providers, over-the-top content providers, or other providers of content. The media content source 1012 may also include a remote media server used to store different types of content (including video content selected by a user), in a location remote from any of the recipient devices 1004, 1006, 1008. The media content source 1012 may also provide metadata that can be used to provide information about the media content (e.g., original picture resolution, color information, scene information, and the like).

The recipient devices 1004, 1006, 1008 may operate in a cloud computing environment to access cloud services. In a cloud computing environment, various types of computing services for content processing, sharing, storage, or distribution (e.g., video sharing sites or social networking sites) are provided by a collection of network-accessible computing and storage resources. For example, the cloud can include a collection of server computing devices (such as, e.g., system 1002), which may be located centrally or at distributed locations, that provide cloud-based services to various types of users and devices connected via a network such as the Internet via communication network 1006. In such embodiments, recipient devices 1004, 1006, 1008 may operate in a peer-to-peer manner without communicating with a central server, and in such an environment, the recipient devices 1004, 1006, 1008 may stream video one another. Such video streaming between recipient devices 1004, 1006, 1008 may include one-way video streaming (e.g., a video streamed from one of the recipient devices 1004, 1006, 1008 to another of the recipient devices 1004, 1006, 1008). Such video streaming may also include two- or multi-way video streaming (e.g., video conferencing between two or more of the recipient devices 1004, 1006, 1008).

FIG. 11 shows generalized embodiments of illustrative recipient devices 1100 and 1102. For example, recipient device 1100 may be a smartphone device. In another example, the recipient device 1102 may be a smart television. In some embodiments, the recipient device 1102 may be a set-top box 1104 that is communicatively connected to a microphone 1106, a speaker 1108, and a display 1110. In some embodiments, the display 1110 may be a television display or a computer display. In some embodiments, the set-top box 1104 may include a user input interface 1112. In some embodiments, the user input interface 1112 may be incorporated into a remote control device. The set-top box 1104 may include one or more circuit boards. In some embodiments, the circuit boards may include control circuitry 1114 (which may include integrated processing circuitry 1116), and storage 1118 (e.g., RAM, ROM, Hard Disk, Removable Disk, etc.). In some embodiments, the storage 1118 may be integrated as part of the control circuitry 1114. In some embodiments, the circuit boards may include an input/output (I/O) path 1120. Some exemplary implementations of recipient devices are discussed above in connection with FIG. 10. Each of the recipient devices 1100, 1102 may receive streaming video via the I/O path 1120. The I/O path 1120 may provide streaming video (e.g., broadcast video, on-demand video, Internet video, video available over a local area network (LAN) or wide area network (WAN), video conferencing videos, and/or other types of video content) and data to the control circuitry 1114. The control circuitry 1114 may be used to send and receive commands, requests, streaming video, and other data using the I/O path 1120, which may include I/O circuitry. The I/O path 1120 may connect the control circuitry 1114 (and specifically the processing circuitry 1116) to one or more communications paths. I/O functions may be provided by one or more of these communications paths but are shown as a single path in FIG. 11 to avoid overcomplicating the drawing.

The control circuitry 1114 may include any suitable processing circuitry such as processing circuitry 1116. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1114 executes instructions for a media application stored in memory (i.e., storage 1118). Specifically, the control circuitry 1114 may be instructed by the media application to perform all or any part of the functions discussed herein. In some implementations, any action performed by control circuitry 1114 may be based on instructions received from the media application.

In client/server-based embodiments, control circuitry 1114 may include communications circuitry suitable for communicating with a media application server or other networks or servers. The instructions for carrying out the above-mentioned functionality may be stored on a server (which is described above in connection with FIG. 10) I/O circuitry may include a cable modem, an integrated services digital network (ISDN) modem, a digital subscriber line (DSL) modem, a telephone modem, Ethernet card, or a wireless modem for communications with other equipment, or any other I/O circuitry suitable for communications. Such communications may involve the Internet or any other suitable communication networks or paths (which is described in above in connection with FIG. 10). In addition, I/O circuitry may include circuitry that enables peer-to-peer communication of recipient devices, or communications of recipient devices in locations remote from each other (described in more detail below).

Memory may be an electronic storage device provided as storage 1118 that is part of control circuitry 1114. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1118 may be used to store various types of content described herein as well as media application data described above. Nonvolatile memory may also be used (e.g., to launch a boot-up routine and other instructions). Cloud-based storage, described above in relation to FIG. 11, may be used to supplement storage 1118 or instead of storage 1118.

The control circuitry 1114 may include video decoding circuitry, such as one or more MPEG-2 decoders or any other circuitry suitable for decoding and processing received streaming video for display by the recipient device. The control circuitry 1114 may also include video encoding circuitry, such as one or more MPEG-2 encoders or any other encoding circuitry suitable for converting source video (e.g., over-the-air video, analog video, and/or digital video to MPEG encoded video for video streaming). The control circuitry 1114 may also include scaler circuitry for upsampling and downsampling video content into the preferred picture resolution format of a recipient device. The control circuitry 1114 may also include digital-to-analog converter circuitry and analog-to-digital converter circuitry for converting between digital and analog video signals. The encoding circuitry may be used by recipient devices 1100, 1102 to receive, decode, resample, display, play, and/or record video content as well as to generate, encode, resample, and stream video content to other recipient devices. The encoding circuitry described herein, including, for example, video generating, encoding, decoding, encrypting, decrypting, scaler, and analog/digital circuitry, may be implemented using software running on one or more general purpose or specialized processors. If the storage 1118 is provided as a separate device from the recipient device 1100, the encoding circuitry may be associated with the storage 1118.

A user may send instructions to the control circuitry 1114 using user the input interface 1112. The user input interface 1112 may be any suitable user interface, such as a remote control, mouse, trackball, keypad, keyboard, touch screen, touchpad, stylus input, joystick, voice recognition interface, or other user input interfaces. The display 1110 may be provided as a stand-alone device or integrated with other elements of each one of recipient devices 1100, 1102. For example, the display 1110 may be a touchscreen or a touch-sensitive display. In such circumstances, the user input interface 1112 may be integrated with or combined with the display 1110. The display 1110 may be one or more of a monitor, a television, a display for a mobile device, or any other type of display. A video card or graphics card may generate the output to the display 1110. The video card may be any processing circuitry described above in relation to the control circuitry 1114. The video card may be integrated with the control circuitry 1114. Speakers 1108 may be provided as integrated with other elements of each one of the recipient devices 1100, 1102. In some embodiments, the speakers 1108 may be stand-alone units. The audio component of videos and other content displayed on the display 1110 may be played through the speakers 1108. In some embodiments, the audio may be distributed to a receiver (not shown), which processes and outputs the audio via speakers 1108.

The media application for streaming and/or receiving streamed video may be implemented using any suitable architecture. For example, the media application may be a stand-alone application wholly implemented on each of the recipient devices 1100, 1102. In such an approach, instructions of the application may be stored locally (e.g., in the storage 1118). The control circuitry 1114 may retrieve instructions of the application from storage 1118 and process the instructions to process received streamed video for display and/or to process source video for streaming. Based on the processed instructions, the control circuitry 1114 may determine what action to perform when video is prepared for streaming and/or received and prepared for display. For example, in video conferencing applications, source video may be generated and processed (e.g., encoded and/or resampled) for streaming to another recipient device, and streamed video may be received and processed (e.g., decoded and/or resampled) for display.

In some embodiments, the media application may be a client/server-based application. Videos for use by a thick or thin client implemented on the recipient devices 1100, 1102 may be retrieved on-demand by issuing requests to a server remote from the recipient devices 1100, 1102. In one example of a client/server-based application, control circuitry 1114 runs a web browser that interprets web pages provided by a remote server. For example, the remote server may store the instructions for the application in a storage device. The remote server may process the stored instructions using circuitry (e.g., control circuitry 1114) to perform the operations discussed in connection with FIGS. 1-9.

Processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based on at least in part on a prior step.

1. A method of live video streaming comprising:
encoding a source video, using the control circuitry, to generate a plurality of first live video streams, each first live video stream based at least in part on the source video at a first picture resolution and encoded at one of a plurality of predetermined bitrates;
determining, using the control circuitry, a first video quality metric for each first live video stream;
generating, using the control circuitry, a streaming manifest comprising encoding parameters associated with each first live video stream and the determined video quality metric for each first live video stream;
receiving, via input/output circuitry, a live stream request for the source video from a recipient device;
communicating, using the input/output circuitry, one of the first live video streams and the streaming manifest to the recipient device based at least in part on receiving the live stream request;
monitoring, using the control circuitry, the source video to determine a complexity metric for a first scene of the source video;
determining, using the control circuitry, a second picture resolution for the source video based at least in part on comparing the complexity metric to a complexity metric threshold, the second picture resolution being different from the first picture resolution;
encoding the source video, using the control circuitry, to generate one or more second live video streams, each second live video stream based at least in part on the source video at the second picture resolution and encoded at one of the plurality of predetermined bitrates;
determining, using the control circuitry, a second video quality metric for each second live video stream;
updating, using the control circuitry, the streaming manifest to incorporate encoding parameters associated with each second live video stream and the determined second video quality metric for each second live video stream; and
communicating, using the input/output circuitry, the updated streaming manifest to the recipient device.

2. The method of claim 1, further comprising evaluating, using the control circuitry, distortion present in each first live video stream using the first picture resolution and a first quantization parameter associated with each first live video stream to determine the first video quality metric.

3. The method of claim 1, further comprising evaluating, using the control circuitry, distortion present in each second live video stream using the second picture resolution and a second quantization parameter associated with each second live video stream to determine the second video quality metric.

4. The method of claim 1, further comprising determining, using the control circuitry, the complexity threshold based at least in part on a categorization of at least one of the source video and the first scene.

5. The method of claim 1, further comprising determining, using the control circuitry, the second picture resolution based at least in part on a categorization of at least one of the source video and the first scene.

6. The method of claim 1, further comprising generating, using the control circuitry, the streaming manifest to include a reload parameter, the reload parameter being an indicator to the recipient device of a frequency for requesting a copy of the streaming manifest.

7. The method of claim 6, further comprising updating, using the control circuitry, the reload parameter to change the frequency for requesting the copy of the streaming manifest.

8. The method of claim 1, further comprising communicating, using the control circuitry and the input/output circuitry, a reload signal to the recipient device based at least in part on the streaming manifest being updated, the reload signal indicating to the recipient device that the updated streaming manifest is available.

9. A system for live video streaming comprising:
input/output circuitry; and
control circuitry configured to:
encode a source video to generate a plurality of first live video streams, each first live video stream based at least in part on the source video at a first picture resolution and encoded at one of a plurality of predetermined bitrates;
determine a first video quality metric for each first live video stream;
generate a streaming manifest comprising encoding parameters associated with each first live video stream and the determined video quality metric for each first live video stream;
receive, via the input/output circuitry, a live stream request for the source video from a recipient device;
communicate, using the input/output circuitry, one of the first live video streams and the streaming manifest to the recipient device based at least in part on the received live stream request;
monitor the source video to determine a complexity metric for a first scene of the source video;
determine a second picture resolution for the source video based at least in part on comparing the complexity metric to a complexity metric threshold, the second picture resolution being different from the first picture resolution;
encode the source video to generate one or more second live video streams, each second live video stream based at least in part on the source video at the second picture resolution and encoded at one of the plurality of predetermined bitrates;
determine a second video quality metric for each second live video stream;
update the streaming manifest to incorporate encoding parameters associated with each second live video stream and the determined second video quality metric for each second live video stream; and
communicate, via the input/output circuitry, the updated streaming manifest to the recipient device.

10. The system of claim 9, wherein the control circuitry is further configured to evaluate distortion present in each first live video stream using the first picture resolution and a first quantization parameter associated with each first live video stream to determine the first video quality metric.

11. The system of claim 9, wherein the control circuitry is further configured to evaluate distortion present in each second live video stream using the second picture resolution and a second quantization parameter associated with each second live video stream to determine the second video quality metric.

12. The system of claim 9, wherein the control circuitry is further configured to determine the complexity threshold based at least in part on a categorization of at least one of the source video and the first scene.

13. The system of claim 9, wherein the control circuitry is further configured to determine the second picture resolution based at least in part on a categorization of at least one of the source video and the first scene.

14. The system of claim 9, wherein the control circuitry is further configured to generate the streaming manifest to include a reload parameter, the reload parameter being an indicator to the recipient device of a frequency for requesting a copy of the streaming manifest.

15. The system of claim 14, wherein the control circuitry is further configured to update the reload parameter to change the frequency for requesting the copy of the streaming manifest.

16. The system of claim 9, wherein the control circuitry is further configured to communicate, using the input/output circuitry, a reload signal to the recipient device based at least in part on the streaming manifest being updated, the reload signal indicating to the recipient device that the updated streaming manifest is available.

17. A non-transitory, computer-readable medium having instructions encoded thereon that when executed by control circuitry cause the control circuitry to:
encode a source video to generate a plurality of first live video streams, each first live video stream based at least in part on the source video at a first picture resolution and encoded at one of a plurality of predetermined bitrates;
determine a first video quality metric for each first live video stream;
generate a streaming manifest comprising encoding parameters associated with each first live video stream and the determined video quality metric for each first live video stream;
receive, via input/output circuitry, a live stream request for the source video from a recipient device;
communicate, using the input/output circuitry, one of the first live video streams and the streaming manifest to the recipient device based at least in part on the received live stream request;
monitor the source video to determine a complexity metric for a first scene of the source video;
determine a second picture resolution for the source video based at least in part on comparing the complexity metric to a complexity metric threshold, the second picture resolution being different from the first picture resolution;
encode the source video to generate one or more second live video streams, each second live video stream based at least in part on the source video at the second picture resolution and encoded at one of the plurality of predetermined bitrates;
determine a second video quality metric for each second live video stream;
update the streaming manifest to incorporate encoding parameters associated with each second live video stream and the determined second video quality metric for each second live video stream; and
communicate, using the input/output circuitry, the updated streaming manifest to the recipient device.

18. The non-transitory, computer-readable medium of claim 17, wherein the instructions further cause the control circuitry to evaluate distortion present in each first live video stream using the first picture resolution and a first quantization parameter associated with each first live video stream to determine the first video quality metric.

19. The non-transitory, computer-readable medium of claim 17, wherein the instructions further cause the control circuitry to evaluate distortion present in each second live video stream using the second picture resolution and a second quantization parameter associated with each second live video stream to determine the second video quality metric.

20. The non-transitory, computer-readable medium of claim 17, wherein the instructions further cause the control circuitry to determine the complexity threshold based at least in part on a categorization of at least one of the source video and the first scene.

21-66. (canceled)
